(19) United States
(12) Patent Application Publication
(10) Pub. No.: US 2024/0367226 A1
(43) Pub. Date: Nov. 7, 2024

(54) METHOD FOR SYNTHESIZING FRAME NANOPARTICLE HAVING POROUS STRUCTURE, AND SURFACE-ENHANCED RAMAN SCATTERING ANALYSIS METHOD USING SAME

(71) Applicant: NUTURN SCIENCE CO., LTD, Seoul (KR)

(72) Inventors: Sung Ho PARK, Suwon-si Gyeonggi-do (KR); Sung Woo LEE, Suwon-si Gyeonggi-do (KR); Soo Hyun LEE, Suwon-si Gyeonggi-do (KR)

(21) Appl. No.: 18/689,142

(22) PCT Filed: Sep. 5, 2022
(86) PCT No.: PCT/KR2022/013263

§ 371 Date: Mar. 5, 2024

(30) Foreign Application Priority Data
Sep. 6, 2021 (KR) 10-2021-0118502

(51) Int. Cl. B22F 1/054; B22F 9/24; B82Y 15/00; C25D 3/46; C25D 7/00; G01N 21/65

(52) U.S. Cl. CPC B22F 1/0553; B22F 9/24; B82Y 15/00; C25D 3/46; C25D 7/006; G01N 21/65; B22F 2301/255; B22F 2304/056

(57) ABSTRACT

An embodiment of the present invention provides a frame-structured nanoparticle of porous-structured comprising: a ring-like shaped frame including a nano-sized internal ring frame and a gold nanoparticle external frame, wherein the nano-sized internal ring frame consists of platinum and the gold nanoparticle external frame surrounds the nano-sized internal ring frame; and a porous nanostructure positioned on inner space of the ring-like shaped frame. The frame-structured nanoparticle of porous-structured according to an embodiment of the present invention has the effect of providing a surface-enhanced Raman scattering analysis method on the basis of the high electromagnetic field focusing effect through the porous nanostructure.

### TECHNICAL FIELD

The present disclosure relates to a method of synthesizing a frame-structured nanoparticle having a porous structure inside and a surface-enhanced Raman scattering analysis method using the same and, more specifically, to a method of synthesizing a frame-structured nanoparticle having a porous structure inside using a galvanic substitution reaction and the Kirkendall effect and a surface-enhanced Raman scattering analysis method using the same.

### BACKGROUND ART

Raman spectroscopy is a method first proposed by an Indian scientist named C. V. Raman to detect an unknown molecule using the nature of absorbing as much light energy as the vibrational energy of the molecule when irradiating the molecule with light. Raman spectroscopy is advantageous in that measurement is available regardless of the state (gas, liquid, and solid) of a sample, and direct measurement is available even when a pretreatment process of the sample for measurement is not performed separately. Despite such advantages, there is a fatal disadvantage in that the effective Raman scattering cross section of the sample is insufficient, so the signal is small compared to that in other spectroscopic methods. A representative method of various methods to overcome such disadvantages is surface-enhanced Raman scattering (SERS) spectroscopy.

Surface-enhanced Raman scattering spectroscopy, an ultrasensitive analysis technique enabling single molecule-level detection, is widely used in the fields of life science, chemical production, environmental management, and the like. Precious metal nanoparticles (gold, silver, or copper nanoparticles) exhibit local surface plasmon resonance and are thus frequently used in surface-enhanced Raman scattering spectroscopy.

In the process of surface-enhanced Raman scattering, a spectroscopic method, a narrow gap is created between metal nanoparticles, and when irradiating the narrow gap with light, an electromagnetic field amplification effect occurs due to local surface plasmon resonance that matches the wavelength of the light irradiated, thus the signal of Raman spectroscopy is increased by about 10⁸ times.

The narrow gap is also called a hot spot. Attempts for creating such the gap have been made by methods, such as a method of creating a gap between nanoparticles and a method of creating a gap within a nanoparticle. The method of creating the gap within a nanoparticle is recognized as desirable among all these methods considering the homogeneity of the resulting product and the homogeneity of the signal in the future Raman scattering signal, while requiring a highly sophisticated technique and also being considered challenging in obtaining a uniform product.

Additionally, there is a problem in that Raman spectroscopy is typically available for nanoparticles only in a specific polarization direction, making it challenging for users to measure surface-enhanced Raman scattering when experiments are performed in other polarization directions.

As described above, surface-enhanced Raman scattering spectroscopy has limitations in that the creation of a nanogap in the molecule is challenging, and Raman spectroscopy is available only in a specific polarization direction. Therefore, there is a need for designing nanoparticles, which are analysis samples for surface-enhanced Raman scattering, to overcome the above difficulties.

### DOCUMENT OF RELATED ART

Korea Patent No. 10-2260209

### DISCLOSURE

### Technical Problem

A technical problem to be solved by the present disclosure is to provide a method of making a ring-like shaped frame made of gold (Au) for surface-enhanced Raman scattering analysis sample, wherein the ring-like shaped frame has a nanogap (porous structure) inside thereof.

Additionally, a technical problem to be solved by the present disclosure is to provide a surface-enhanced Raman scattering analysis sample having good sensitivity, which does not have limitation with regarding to a direction for polarization.

The technical problems to be solved by the present disclosure is not limited to the technical problems mentioned above, and other technical problems not mentioned can be clearly understood by those skilled in the art from the description below.

### Technical Solution

To solve the technical problems mentioned above, the present disclosure provides a frame-structured nanoparticle of a porous structure and a method for preparing the same. And the heightened electromagnetic field focusing effect of porous nano-sized structure, resulting from the porous structure within an inner space of a ring-like shaped frame made of gold or the ring-like shaped frame itself, enhances the sensitivity in a surface-enhanced Raman scattering analysis method.

To solve the technical problems mentioned above, an embodiment of the present disclosure provides a frame-structured nanoparticle of porous-structured, the nanoparticle characterized by having a ring-like shaped frame including a nano-sized internal ring frame and a gold nanoparticle external frame, in which the nano-sized internal ring frame contains platinum, the gold nanoparticle external frame surrounds the nano-sized internal ring frame, and the gold nanoparticle external frame is a porous structure.

In the embodiment of the present disclosure, the frame-structured nanoparticle of porous-structured may be characterized in that the porous nano-sized structure consists of nanoparticles that are entangled to each other, which provides a geometrically symmetric structure, in which the geometrically symmetric structure allows near-infrared rays incident on the porous nano-sized structure in all directions to be Raman-scattered.

To solve the technical problems mentioned above, a second embodiment of the present disclosure provides a method of making a frame-structured nanoparticle of porous-structured, the method characterized by including the following steps of: preparing a ring-like shaped frame including a nano-sized internal ring frame and a gold nanoparticle external frame, in which the nano-sized internal ring frame containing platinum, and the gold nanoparticle external frame surrounds the nano-sized internal ring frame; depositing silver on a surface of the ring-like shaped frame such that silver is deposited in a concentric manner on the ring-like shaped frame; and performing a galvanic substitution reaction after the step of depositing silver, such that the deposited silver is substituted, forming a gold nanoparticle external frame of porous-structured.

In the embodiment of the present disclosure, the method of making the frame-structured nanoparticle of porous-structured may be characterized in that the step of depositing silver involves a step of controlling standard reduction potential of silver by using a solution including halogen anions and silver anions and applying a potential higher than both the inner-side surface energy of the ring-like shaped frame and outer-side surface energy of the ring-like shaped frame, which allows the silver to be deposited in a concentric manner.

Additionally, in the embodiment of the present disclosure, the method of making the frame-structured nanoparticle of porous-structured may be characterized in that the step of performing the galvanic substitution reaction involves a step of adding a compound providing Au³⁺ cations to allow a reaction of Reaction Scheme 1 as below, or adding a compound providing Pt⁴⁺ cations to allow a reaction of Reaction Scheme 2 as below:

3Ag(s)+AuX⁻(aq)->Au(s)+3Ag⁺(aq)+4X⁻(aq) [Reaction Scheme 1]

X is a halogen element.

4Ag(s)+Pt⁴⁺(aq)->Pt(s)+4Ag⁺(aq) [Reaction Scheme 2]

Additionally, in the embodiment of the present disclosure, the method of making the frame-structured nanoparticle of porous-structured may be characterized in that the step of performing the galvanic substitution reaction involves a Kirkendall reaction, in which the Kirkendall reaction involves: an oxidation of silver on the surface causing dissolving of Ag⁺(aq); a migration of silver inside of metal into the surface for minimizing surface energy; and an oxidation of the silver migrated into the surface.

To solve the technical problems mentioned above, a third embodiment of the present disclosure provides a frame-structured nanoparticle of porous-structured, the nanoparticle characterized by having: a ring-like shaped frame including a nano-sized internal ring frame and a gold nanoparticle external frame, in which the nano-sized internal ring frame contains platinum, and the gold nanoparticle external frame surrounds the nano-sized internal ring frame; and a porous nanostructure positioned on an inner space of the ring-like shaped frame, the gold nanoparticle external frame having a porous structure.

In the embodiment of the present disclosure, the frame-structured nanoparticle of porous-structured may be characterized in that the porous nano-sized structure consists of nanoparticles that are entangled to each other, which provides a geometrically symmetric structure, in which the geometrically symmetric structure allows near-infrared rays incident on the porous nano-sized structure in all directions to be Raman-scattered.

To solve the technical problems mentioned above, a fourth embodiment of the present disclosure provides a method of making a frame-structured nanoparticle of porous-structured, the method characterized by including the following steps of: preparing a ring-like shaped frame including a nano-sized internal ring frame and a gold nanoparticle external frame, in which the nano-sized internal ring frame contains platinum, and the gold nanoparticle external frame surrounds the nano-sized internal ring frame; depositing silver in a concentric manner on the ring-like shaped frame such that the surface of the ring-like shaped frame is surrounded by silver; depositing silver in an eccentric manner after the step of depositing silver in a concentric manner, such that an inner space of the ring-like shaped frame is deposited by silver; and performing a galvanic substitution reaction after the step of depositing silver in an eccentric manner, such that the deposited silver is substituted, forming a gold porous structure.

In the embodiment of the present disclosure, the method of making the frame-structured nanoparticle of porous-structured may be characterized in that the step of depositing silver involves a step of controlling standard reduction potential of silver by using a solution including halogen anions and silver anions and applying a potential higher than both the inner-side surface energy of the ring-like shaped frame and outer-side surface energy of the ring-like shaped frame, which allows the silver to be deposited in a concentric manner.

Additionally, in the embodiment of the present disclosure, the method of making the frame-structured nanoparticle of porous-structured may be characterized in that the step of depositing silver in an eccentric manner is performed after the step of depositing silver in a concentric manner to induce the ring-like shaped frame to be deposited by silver.

Additionally, in the embodiment of the present disclosure, the method of making the frame-structured nanoparticle of porous-structured may be characterized in that the step of performing the galvanic substitution reaction involves a step of adding a compound providing Au³⁺ cations to allow a reaction of Reaction Scheme 1 as below, or adding a compound providing Pt⁴⁺ cations to allow a reaction of Reaction Scheme 2 as below:

3Ag(s)+AuX⁻(aq)->Au(s)+3Ag⁺(aq)+4X⁻(aq) [Reaction Scheme 1]

X is a halogen element.

4Ag(s)+Pt⁴⁺(aq)->Pt(s)+4Ag⁺(aq) [Reaction Scheme 2]

Additionally, in the embodiment of the present disclosure, a method of making a porous nanolens particle may be characterized in that the step of performing the galvanic substitution reaction involves a Kirkendall reaction, in which the Kirkendall reaction involves: an oxidation of silver on the surface causing dissolving of Ag⁺(aq); a migration of silver inside of metal into the surface for minimizing surface energy; and an oxidation of the silver migrated into the surface.

To solve the technical problems mentioned above, a fifth embodiment of the present disclosure provides a frame-structured nanoparticle of porous-structured, the nanoparticle characterized by having: a ring-like shaped frame including a nano-sized internal ring frame and a gold nanoparticle external frame, in which the nano-sized internal ring frame contains platinum, and the gold nanoparticle external frame surrounds the nano-sized internal ring frame; and a porous nanostructure positioned on an inner space of the ring-like shaped frame.

In the embodiment of the present disclosure, the frame-structured nanoparticle of porous-structured may be characterized in that the porous nanostructure includes an inner part of the porous nanostructure and an outer part of the porous nanostructure, in which the inner part of the porous nanostructure has a structure which consists of nanoparticles that are entangled to each other, and the outer part of the porous nanostructure is connected to the ring-like shaped frame.

Additionally, in the embodiment of the present disclosure, the frame-structured nanoparticle of porous-structured may be characterized in that the porous nanostructure consists of nanoparticles that are entangled to each other, which provides a geometrically symmetric structure, and the geometrically symmetric structure allows near-infrared rays incident on the porous nano-sized structure in all directions to be Raman-scattered.

Additionally, in the embodiment of the present disclosure, the frame-structured nanoparticle of porous-structured may be characterized in that the ring-like shaped frame has an outer portion of the nano-sized external frame which has a triangular to hexagonal structure.

Additionally, in the embodiment of the present disclosure, the frame-structured nanoparticle of porous-structured may be characterized in that a thickness of the ring-like shaped frame is within 39 nm to 51 nm, an outer diameter of the ring-like shaped frame is within 103 nm to 150 nm, and an inner diameter of the ring-like shaped frame is within 35 nm to 54 nm.

To solve the technical problems mentioned above, a sixth embodiment of the present disclosure provides a method of making a frame-structured nanoparticle of porous-structured, the method characterized by including the following steps of: preparing a ring-like shaped frame including a nano-sized internal ring frame and a gold nanoparticle external frame, in which the nano-sized internal ring frame contains platinum, and the gold nanoparticle external frame surrounds the nano-sized internal ring frame; depositing silver in an eccentric manner on the ring-like shaped frame such that the silver is deposited on an inner space of the ring-like shaped frame; and performing a galvanic substitution reaction after the step of depositing silver, such that the deposited silver is substituted, forming a porous structure.

In the embodiment of the present disclosure, the method of making the frame-structured nanoparticle of porous-structured may be characterized in that the step of depositing silver in an eccentric manner involves a step of controlling standard reduction potential of silver by using a solution including halogen anions and silver anions, and applying a potential between the inner-side surface energy of the ring-like shaped frame and the outer-side surface energy of the ring-like shaped frame, which allows the silver to be deposited in an eccentric manner.

Additionally, in the embodiment of the present disclosure, the method of making the frame-structured nanoparticle of porous-structured may be characterized in that the halogen anion includes a bromine ion.

Additionally, in the embodiment of the present disclosure, the method of making the frame-structured nanoparticle of porous-structured may be characterized in that the step of performing the galvanic substitution reaction involves a step of adding a compound providing Au³⁺ cations to allow a reaction of Reaction Scheme 1 as below, or adding a compound providing Pt⁴⁺ cations to allow a reaction of Reaction Scheme 2 as below:

3Ag(s)+Au^{X-}(aq)->Au(s)+3Ag+(aq)+4X⁻(aq) [Reaction Scheme 1]

X is a halogen element.

4Ag(s)+Pt⁴⁺(aq)->Pt(s)+4Ag⁺(aq) [Reaction Scheme 2]

Additionally, in the embodiment of the present disclosure, the method of making a nanolens particle containing a porous nanostructure nanoparticle may be characterized in that the step of performing the galvanic substitution reaction involves a Kirkendall reaction, in which the Kirkendall reaction involves: an oxidation of silver on the surface causing dissolving of Ag⁺ (aq); a migration of silver inside of metal into the surface for minimizing surface energy; and an oxidation of the silver migrated into the surface.

To solve the technical problems mentioned above, the present disclosure provides a spectroscopy sample for surface-enhanced Raman scattering (SERS), the sample characterized by containing the frame-structured nanoparticle of porous-structured.

### Advantageous Effects

According to one embodiment of the present disclosure, a porous nanostructure made of gold can be formed within a ring-shaped frame of a nanoparticle made of gold.

Additionally, the high electromagnetic field focusing effect can be obtained through the porous nanostructure made of gold, and an effective surface-enhanced Raman scattering analysis method can be ultimately provided.

However, the effects of the present disclosure are not limited to the above effects, and should be construed to include all effects that can be inferred from the detailed description of the present disclosure or the configuration of the disclosure described in the claims.

### DESCRIPTION OF DRAWINGS

FIGS. 1 to 3 are diagrams summarizing a method of making a frame-structured nanoparticle (Au Web-Above-a-Ring, WAR) (10) having a porous structure in a gold nanoparticle external frame, a method of making a frame-structured nanoparticle (Au Web-Above-a-Lens, WAL) (30) having a porous structure in both an external frame and a nanostructure positioned on an inner space of a ring-like shaped frame, and a method of making a frame-structured nanoparticle (Au Nanolens, AN) (40) containing a nanostructure having a porous nanostructure positioned on an inner space of a ring-like shaped frame, provided by embodiments of the present disclosure.

FIG. 4 is a diagram illustrating a cross-sectional view of a ring-like shaped frame.

FIG. 5 is a diagram illustrating a cross section of a frame-structured nanoparticle of porous-structured provided by one embodiment of the present disclosure, in which the nanoparticle is characterized by having: a ring-like shaped frame including a nano-sized internal ring frame (100) consisting of platinum and a gold nanoparticle external frame (200) surrounding the nano-sized internal ring frame; and a nanostructure (300) having a plurality of pores (400), wherein the nanostructure positioned on an inner space of the ring-like shaped frame.

FIG. 6 is a diagram illustrating frame-structured nanoparticles formed by varying the particle size of a porous nanostructure (300) positioned on an inner space of the ring-like shaped frame in the frame-structured nanoparticle of porous-structured provided by one embodiment of the present disclosure.

FIG. 7 shows SEM images, TEM images, and EDS mapping images for each step until a frame-structured nanoparticle (Au Nanolens, AN) (40) containing a porous is synthesized from nano-sized internal ring frame (100) consisting of platinum, using the present disclosure.

FIG. 8 shows UV-vis-NIR optical spectra for each step until a frame-structured nanoparticle (Au Nanolens, AN) (40) comprising a porous nanostructure positioned on an inner space of a ring-like shaped frame is synthesized from the ring-like shaped frame including a platinum-containing nano-sized internal ring frame (100) and a gold nanoparticle external frame (200), using the present disclosure.

FIG. 9 shows results of confirming the electromagnetic field focusing effect of a frame-structured nanoparticle formed by varying the particle size of a porous nanostructure (300) in a frame-structured nanoparticle (Au Nanolens, AN) (40) containing a porous nanostructure, synthesized using the present disclosure, through theoretical computer calculation results and detecting a target material by applying a single-particle surface-enhanced Raman analysis method.

FIG. 10 shows SEM images, TEM images, EDS mapping images, and UV-vis-NIR optical spectra for each step until a frame-structured nanoparticle (Au Web-Above-a-Ring, WAR) (10) having a porous structure in a gold nanoparticle external frame is synthesized from a ring-shaped frame including a platinum-containing nano-sized internal ring frame (100) and a gold nanoparticle external frame (200), using the present disclosure.

FIG. 11 shows SEM images, TEM images, EDS mapping images, and UV-vis-NIR optical spectra of a frame-structured nanoparticle (Au Web-Above-a-Ring, WAR) (10) having a porous structure in a gold nanoparticle external frame when adjusting the gap between the porous structure and the gold nanoparticle external frame (200), using the present disclosure.

FIG. 12 shows a result of confirming the electromagnetic field focusing effect of a frame-structured nanoparticle (Au Web-Above-a-Ring, WAR) (10) having a porous structure in a gold nanoparticle external frame, synthesized using the present disclosure, through theoretical computer calculation results and detecting a target material by applying a single-particle surface-enhanced Raman analysis method.

FIG. 13 shows SEM images, UV-vis-NIR optical spectra, and single-particle surface-enhanced Raman analysis results of a frame-structured nanoparticle (Au Web-Above-a-Lens, WAL) (30) having a porous structure in both an external frame and a nanostructure positioned on an inner space of a ring-like shaped frame, synthesized using the present disclosure.

### MODE FOR INVENTION

Hereinafter, the present disclosure will be described with reference to the attached drawings. However, the present disclosure may be implemented in many different forms and, therefore, is not limited to the embodiments and examples set forth herein. To clearly describe the present disclosure in the drawings, parts that are not related to the description are omitted, and similar elements are denoted by corresponding reference numerals throughout the present specification.

It will be understood that when an element is referred to as being “connected (led, contacted, or coupled)” to another element, it can be “directly connected” to the other element or it can be “indirectly connected” to the other element with other elements being interposed therebetween. In addition, it will be understood that when a component is referred to as being “comprising or including” any component, it does not exclude other components, but can further comprise or include the other components unless otherwise specified.

The terms used in this specification are only used to describe specific embodiments and are not intended to limit the disclosure. As used herein, the singular forms “a”, “an”, and “the” are intended to include the plural forms as well unless the context clearly indicates otherwise. It will be further understood that the terms “comprises”, “includes”, or “has” used herein specify the presence of stated features, regions, integers, steps, operations, elements, and/or components, but do not preclude the presence or addition of one or more other features, regions, integers, steps, operations, elements, components, and/or combinations thereof.

Hereinafter, embodiments of the present disclosure will be described in detail with reference to the attached drawings.

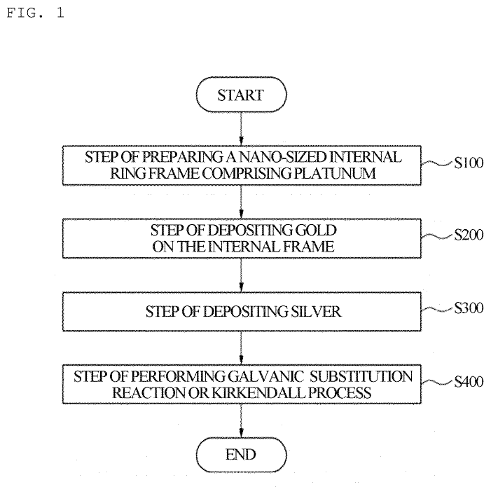

FIGS. 1 to 3 are diagrams summarizing a method for making a frame-structured nanoparticle (Au Web-Above-a-Ring, WAR) (10) having a porous structure in a gold nanoparticle external frame, a method for making a frame-structured nanoparticle (Au Web-Above-a-Lens, WAL) (30) having a porous structure in both an external frame and a nanostructure positioned on an inner space of a ring-like shaped frame, and a method for making a frame-structured nanoparticle (Au Nanolens, AN) (40) having a porous structure positioned on an inner space of a ring-like shaped frame, provided by embodiments of the present disclosure.

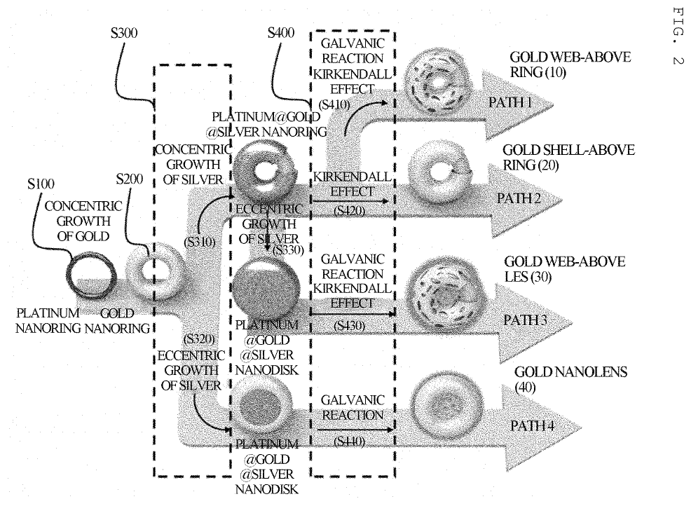

According to FIGS. 1 and 2, the methods for making WAR (10), WAL (30), and AN (40), provided by embodiments of the present disclosure, mainly involve four steps.

This may include a first step (S100) of preparing a nano-sized ring comprising platinum, serving as an internal frame; a second step (S200) of preparing a ring-like shaped frame by applying a metal, serving as an external frame, through a galvanic substitution reaction using gold on the nano-sized ring; a third step (S300) of depositing silver on the resulting gold-platinum nano-sized ring; and a fourth step (S400) of performing a galvanic substitution reaction or a Kirkendall process.

Hereinafter, each step will be explained in detail.

Hereinafter, the first step (S100) and the second step (S200) will be described.

The first step (S100) and the second step (S200) are steps for preparing the ring-like shaped frame of the present disclosure. The first step for preparing the nano-sized internal ring frame comprising platinum (S100) and the second step for preparing the ring-like shaped frame including the gold nanoparticle external frame by reducing a gold precursor on the surface of the nano-sized internal ring frame (S200) are described in detail in existing Korean Patent No. 10-2260209.

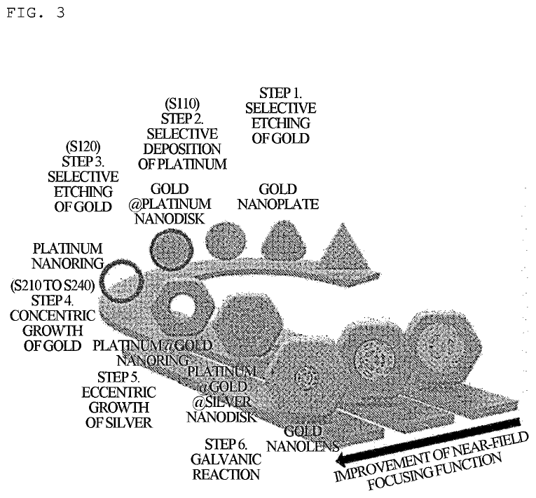

When briefly described with reference to FIG. 3 and the registered patent mentioned above, the ring-shaped frame, including the gold nanoparticle external frame, may be formed by: a step of forming a first platinum layer having a closed loop structure on an edge area of a two-dimensional gold nanoparticle (S110); a step of forming a single-frame structure by removing an exposed central area of the gold nanoparticle from the first platinum layer (S120); a step of growing a first gold thin film on the single-frame structure (S210); a step of forming a second platinum layer on the inner and outer edge areas of the first gold thin film (S220); a step of forming a double-frame structure including an internal frame having a closed loop structure and an external frame having a closed loop structure surrounding the internal frame, a portion of which is connected to the internal frame, by removing an exposed area of the first gold thin film from the second platinum layer (S230); and a step of forming a second gold thin film on the surface of the double-frame structure (S240).

Hereinafter, the step of depositing silver (S300) will be described.

In the step of depositing silver on the gold-platinum nano-sized ring (S300), deposition proceeds by reducing silver using an ascorbic acid-based reducing agent. The manner of the deposition process may be mainly divided into a concentric manner (S310) and an eccentric manner (S320).

In the reduction reaction (S300) of silver ions for depositing silver, the standard reduction potential of silver ions may be controlled by incorporating halide anions in the solution comprising the silver ions (Ag⁺). Additionally, the potential value applied from the outside may also be regulated through this process.

In this case, bromine ions (Br⁻) and chloride ions (Cl⁻) may be used as the halide anions. However, the halide anions are not limited thereto, and all halide anions capable of controlling the standard reduction potential of the silver ions should be construed as being included in the scope of the present disclosure.

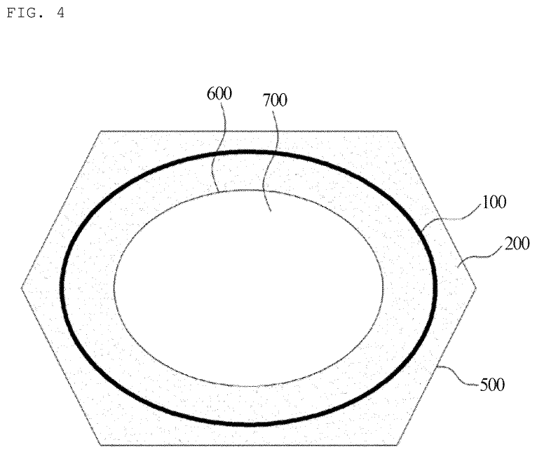

FIG. 4 is a diagram illustrating a cross-sectional view of the ring-like shaped frame. Referring to FIG. 4, the gold nanoparticle external frame (200), surrounding the platinum-containing nano-sized internal ring frame (100), includes an outer-side (500) of the external frame and an inner-side (600) of the external frame. Additionally, as will be described later, the inner space (700) of the ring-like shaped frame has a space (700) where silver may be deposited.

In this case, the outer-side (500) of the external frame has a hexagonal form in FIG. 4 but is not limited thereto and may have various structures, including a triangular, hexagonal, or circular form.

The external frame (200) having a hollow structure on the inner space (700) has a circular structure on the inner-side (600) of the external frame and a hexagonal structure on the outer-side (500) of the external frame. Accordingly, the surface energy also varies at the boundary between the inner-side and the outer-side of the external frame. In this case, the inner-side (600) of the external frame, having a circular structure, has higher crystallographic facet, and thus has higher reactivity as well as higher surface energy.

In this case, when the potential applied during the reduction reaction of silver is higher than both the surface energy of the inner-side (E_{inner-boundary}) and the surface energy of the outer-side (E_{outer-boundary}), silver will be deposited in a concentric manner such that the reduction reaction is performed in both the inner-side (600) and the outer-side (500) (S310). On the contrary, when the potential applied during the reduction reaction of silver is between the surface energy of the inner-side (E_{inner-boundary}) and the surface energy of the outer-side (E_{outer-boundary}), silver will be deposited in an eccentric manner such that the reduction reaction is performed first in the inner-side (S320).

Thus, for selective etching on the inner-side, a potential having a value between the surface energy of the inner-side and the surface energy of the outer-side is preferably applied.

In this case, for depositing silver in a manner such that the ring-like shaped frame is entirely covered, depositing silver in a concentric manner (S310) may proceed first and then depositing silver in an eccentric manner (S330) may proceed. This is because if depositing silver in an eccentric manner proceed first, silver will be deposited only inside the ring-like shaped frame due to the surface energy difference.

Hereinafter, the step of performing the galvanic substitution reaction or the Kirkendall reaction (S400) will be explained.

First, the galvanic substitution reaction will be explained.

The galvanic substitution reaction is an electrochemical reaction occurring when a metal encounters a metal ion having a higher reduction potential than itself. When Au³⁺ cations or Pt⁴⁺ cations is added to silver, the galvanic substitution reaction is performed. In this case, the reaction represented by Reaction Scheme 1 or 2 below is performed.

3Ag(s)+AuX⁻(aq)->Au(s)+3Ag⁺(aq)+4X⁻(aq) [Reaction Scheme 1]

X is a halogen element.

4Ag(s)+Pt⁴⁺(aq)->Pt(s)+4Ag⁺(aq) [Reaction Scheme 2]

When using the galvanic substitution reaction represented

by Reaction Scheme 1, 3 equivalents of Ag(s) are oxidized and dissolved while only 1 equivalent of Au(s) is reduced. In other words, as the oxidation rate of silver is faster than the oxidation rate of gold during the galvanic substitution reaction, a hollow space is created in the entire metal mixture, and holes are ultimately created, thereby porous structure is formed.

For the same reason as the reaction principle described above, even when using Pt⁴⁺ cations, 4 equivalents of Ag(s) are oxidized and dissolved while only 1 equivalent of Pt(s) is reduced, thereby the porous structure is formed in the same manner as described above.

Hereinafter, the Kirkendall reaction will be explained.

The Kirkendall reaction (effect) refers to an effect regarding the motion of the interface between metal atoms, where the movement direction of an alloy means to migrate in a direction that minimizes the surface energy. In other words, in an alloy where silver and gold are mixed, as silver has a lower surface energy than gold, silver within the mixture may migrate to the surface.

Considering both the galvanic substitution reaction and the Kirkendall reaction, in the alloy where silver and gold are mixed, as the silver is continuously dissolved by the galvanic substitution reaction with gold ions, gold nanoparticles will occupy the voids created dissolution of the silver. In this case, due to the Kirkendall effect, the gold nanoparticles migrate into the inner space of the alloy, and the silver atoms present in the alloy migrate to the surface of the alloy. The galvanic substitution reaction may be repeated with silver atoms that have migrated to the surface of the alloy. Additionally, with the repeatedly performed reaction, the nanostructure may have the porous structure.

Hereinafter, the method for making the frame-structured nanoparticle (Au Web-Above-a-Ring, WAR) (10) having the porous structure in the gold nanoparticle external frame will be described.

The frame-structured nanoparticle (Au Web-Above-a-Ring, WAR) (10) having the porous structure in the gold nanoparticle external frame is characterized by having the porous structure in the ring-like shaped frame. To induce the porous structure in the frame itself, a process of depositing silver on the ring-like shaped frame may be performed first. Thus, the silver should be deposited in a concentric manner (S310). When the porous structure is created by the reduction reaction of the deposited silver, WAR may be ultimately obtained.

Additionally, the porous nanostructure comprises an inner

part of the porous nanostructure having a structure in which nanoparticles constituting the porous nanostructure are entangled to each other, and an outer part of the porous nanostructure connected to the ring-like shaped frame, thereby forming a sturdy nanostructure.

Hereinafter, the method for making the frame-structured nanoparticle (Au Web-Above-a-Lens, WAL) (30) having the porous structure in both the external frame and the nanostructure positioned on the inner space of the ring-like shaped frame will be described.

To enable both the external frame and the nanostructure positioned on the inner space of the ring-like shaped frame to have the porous structure, silver may be first deposited in a concentric manner on the external frame (S310).

After the ring-like shaped frame is entirely deposited by silver (S330), the frame-structured nanoparticle having the porous structure in both the external frame and the nanostructure positioned on the inner space of the ring-like shaped frame may be obtained through a galvanic substitution reaction (S430).

Hereinafter, the method of making the frame-structured nanoparticle (Au Nanolens, AN) (40) having the the porous structure in the nanostructure positioned on the inner space of the ring-like shaped frame will be described.

Silver is deposited on the prepared ring-like shaped frame in an eccentric manner (S320). In the eccentric process, halogen elements may be used. When halogen elements are used, the standard reduction potential of Ag⁺ may be controlled, enabling the deposition to be performed more efficiently.

In this case, the halogen elements may include bromide ions or chloride ions but are not limited thereto.

After undergoing the deposition process described above, a galvanic substitution reaction (S440) may be performed. In this process, silver is deposited only in the inner space (700) of the ring-like shaped frame. Thus, the porous nanostructure may be present only in the inner space through the galvanic substitution reaction.

Hereinafter, the effect of the frame-structured nanoparticle containing the nanostructure having the porous structure in surface-enhanced Raman scattering spectroscopy will be explained.

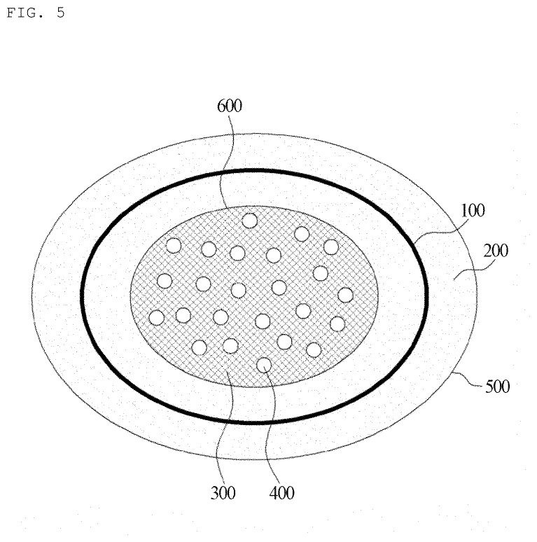

FIG. 5 is a diagram illustrating a cross section of the frame-structured nanoparticle of porous-structured provided by one embodiment of the present disclosure, wherein the frame-structured nanoparticle comprises the ring-like shaped frame including the nano-sized internal ring frame consisting of platinum (100) and the gold nanoparticle external frame (200) surrounding the nano-sized internal ring frame; and the nanostructure (300) having a plurality of pores (400) positioned on the inner space of the ring-like shaped frame.

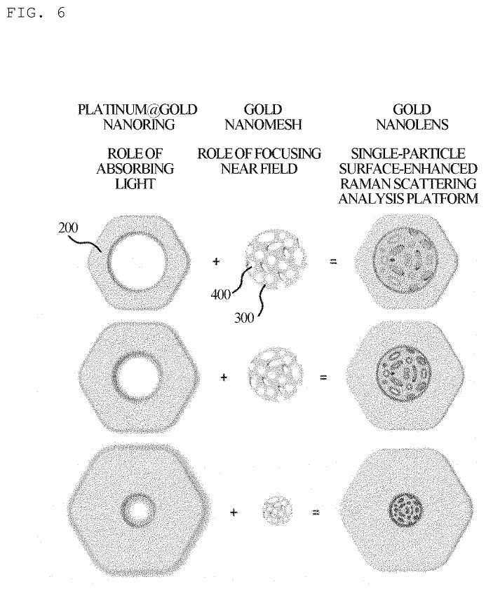

FIG. 6 is a diagram illustrating frame-structured nanoparticles having various particle size of the porous nanostructure (300) positioned on the inner space of the ring-like shaped frame in the frame-structured nanoparticle of porous-structured provided by one embodiment of the present disclosure.

Referring to FIGS. 5 and 6, when using the frame-structured nanoparticle of porous-structured in surface-enhanced Raman scattering spectroscopy, an amplification effect may occur due to the effective concentration of the near electromagnetic field in the nanostructure (300) by light absorbed and scattered by the external frame (200) in the porous (400) nanostructure (400) of the nanoparticle. Accordingly, this enables more efficient results to be obtained in surface-enhanced Raman scattering spectroscopy.

Additionally, the porous structure is not necessarily required to be present in the inner space of the ring-like shaped frame, and even when being present on the external frame (200), an efficient effect may be obtained in surface-enhanced Raman scattering spectroscopy.

Additionally, since the structure of the frame-structured nanoparticle of porous-structured, described above, is entirely a geometrically symmetric structure, the application of the surface-enhanced Raman scattering spectroscopy method using the nanoparticle may not be constrained by a specific wavelength or polarization direction.

In this case, the size of the frame-structured nanoparticle of porous-structured is preferably within 103 nm to 150 nm. When the size of the frame-structured nanoparticle of porous-structured is smaller than 134 nm, the particle size is excessively small that the near fields may fail to recognize the nanoparticles and diffract. When the size of the frame-structured nanoparticle of porous-structured exceeds 150 nm, the particle size is excessively large, making it difficult to effectively focus the near fields into the porous structure.

Additionally, in the porous nanostructure (300) positioned on the inner space of the ring-like shaped frame of the frame-structured nanoparticle of porous-structured, the smaller the entire size of the porous nanostructure (300), the more effectively the near fields may be focused, enabling a more Accordingly, this enables more efficient amplified effect. results to be obtained in surface-enhanced Raman scattering spectroscopy.

Hereinafter, the present disclosure will be described in more detail through preparation, comparative, and experimental examples. However, the present disclosure is not limited to the following preparation and experimental examples.

### Preparation Example 1

In Preparation Example 1, a frame-structured nanoparticle (Au Nanolens, AN) (40) containing a nanostructure having a porous structure positioned on an inner space of a ring-like shaped frame was prepared.

The nanoparticle was prepared through the following process corresponding to a specific preparation process.

All reactions occurred in an aqueous solution phase, and nanoparticles and reagents used were dispersed in tertiary distilled water.

First, a disk-form gold nanoparticle is prepared.

Next, in the presence of 50 μM iodine ions, 8 mL of the disk-form gold nanoparticle, 30 mL of 0.1 M hexadecyltrimethylammonium bromide (CTAB), 50 μL of 2 mM silver nitrate, and 960 μL of a 0.1 M ascorbic acid solution were added and mixed. Then, the mixed solution was maintained at 70° C. for 1 hour to form a silver thin film.

Next, 960 μL of 0.1 M hydrochloric acid and 200 μL of a 2 mM H₂PtCl₆ aqueous solution were added to the mixed solution. Then, a galvanic substitution reaction was performed on the resulting mixture at 70° C. for 12 hours to form a first platinum layer on the edge of the gold nanoparticle.

Next, using a centrifuge, the nanoparticle having a form in which the platinum layer was formed on the edge of the gold nanoparticle was separated from the reagents remaining after the reaction. Then, a dilution process using distilled water was repeatedly performed twice to stop the reaction.

Next, the gold nanoparticle in which the first platinum layer was formed was added to an aqueous solution in which 50 μL of 20 mM HAuCl₄ was added to 10 mL of a 0.1 M CTAB aqueous solution. Then, the gold portion was selectively etched at 50° C. for 30 minutes to synthesize a platinum single-frame structure.

Next, using a centrifuge, the synthesized nanoparticle was separated from the reagents remaining after the reaction. Then, a dilution process using distilled water was repeatedly performed twice to stop the reaction.

To obtain a platinum-containing nano-sized internal ring frame (100), 100 μL of 0.05 M CTAB, 30 μL of 2 mM HAuCl₄, 300 μL of 0.1 M ascorbic acid, and 20 μL of 0.1 M hydrochloric acid reacted in the presence of 50 μM iodine ions at 30° C. for 30 minutes in 100 μL of the platinum single-frame structure.

Next, using a centrifuge, the synthesized nanoparticle was separated from the reagents remaining after the reaction. Then, a dilution process using distilled water was repeatedly performed three times to stop the reaction.

To deposit silver in an eccentric manner on the gold-platinum nano-sized ring (S320), 500 μL of 0.1 M CTAB, 360 μL of 0.2 mM AgNO₃, 200 μL of 0.01 M ascorbic acid, and 200 μL of 50 mM sodium hydroxide were added to 100 μL of the nano-sized internal ring frame (100) and then reacted at 30° C. for 30 minutes.

Next, using a centrifuge, the synthesized nanoparticle was separated from the reagents remaining after the reaction. Then, a dilution process using distilled water was repeatedly performed three times to stop the reaction.

To synthesize the frame-structured nanoparticle (Au Nanolens, AN) (40) containing the porous nanostructure through a galvanic substitution reaction, 500 μL of 0.1 M hexadecyltrimethylammonium chloride (CTAC) and 40 μL of 0.2 mM HAuCl₄ were added to 100 μL of nanoparticle having a form in which silver was deposited on the gold-platinum nano-sized ring in an eccentric manner and then reacted at 30° C. for 30 minutes.

Next, using a centrifuge, the synthesized nanoparticle was separated from the reagents remaining after the reaction. Then, a dilution process using distilled water was repeatedly performed three times to stop the reaction.

Through the process described above, the frame-structured nanoparticle containing the nanostructure was successfully synthesized in Preparation Example 1.

### Preparation Example 2

In Preparation Example 2, a frame-structured nanoparticle (Au Web-Above-a-Ring, WAR) (10) having a porous structure in a gold nanoparticle external frame was prepared.

The nanoparticle was prepared through the following process corresponding to a specific preparation process.

All reactions occurred in an aqueous solution phase, and nanoparticles and reagents used were dispersed in tertiary distilled water.

First, a disk-form gold nanoparticle was prepared.

Next, in the presence of 50 μM iodine ions, 8 mL of the disk-form gold nanoparticle, 30 mL of 0.1 M hexadecyltrimethylammonium bromide (CTAB), 50 μL of 2 mM silver nitrate, and 960 μL of a 0.1 M ascorbic acid solution were added and mixed. Then, the mixed solution was maintained at 70° C. for 1 hour to form a silver thin film.

Next, 960 μL of 0.1 M hydrochloric acid and 200 μL of a 2 mM H₂PtCl₆ aqueous solution were added to the mixed solution. Then, a galvanic substitution reaction was performed on the resulting mixture at 70° C. for 12 hours to form a first platinum layer on the edge of the gold nanoparticle.

Next, using a centrifuge, the nanoparticle having a form in which the platinum layer was formed on the edge of the gold nanoparticles was separated from the reagents remaining after the reaction. Then, a dilution process using distilled water was repeatedly performed twice to stop the reaction.

Next, the gold nanoparticle in which the first platinum layer was formed was added to an aqueous solution in which 50 μL of 20 mM HAuCl₄ was added to 10 mL of a 0.1 M CTAB aqueous solution. Then, the gold portion was selectively etched at 50° C. for 30 minutes to synthesize a platinum single-frame structure.

Next, using a centrifuge, the synthesized nanoparticle was separated from the reagents remaining after the reaction. Then, a dilution process using distilled water was repeatedly performed twice to stop the reaction.

To obtain a platinum-containing nano-sized internal ring frame (100), 100 μL of 0.05 M CTAB, 30 μL of 2 mM HAuCl₄, 300 μL of 0.1 M ascorbic acid, and 20 μL of 0.1 M hydrochloric acid reacted in the presence of 50 μM iodine ions at 30° C. for 30 minutes in the 100 μL of the platinum single-frame structure.

Next, using a centrifuge, the synthesized nanoparticle was separated from the reagents remaining after the reaction. Then, a dilution process using distilled water was repeatedly performed three times to stop the reaction.

To deposit silver in a concentric manner on the gold-platinum nano-sized ring (S310), 500 μL of 0.1 M hexadecyltrimethylammonium chloride (CTAC), 360 μL of 0.2 mM AgNO₃, 200 μL of 0.01 M ascorbic acid, and 200 μL of 50 mM sodium hydroxide were added to 100 μL of the nano-sized internal ring frame (100) and then reacted at 30° C. for 30 minutes.

Next, using a centrifuge, the synthesized nanoparticle was separated from the reagents remaining after the reaction. Then, a dilution process distilled water was repeatedly performed three times to stop the reaction.

To synthesize the frame-structured nanoparticle (Au Web-Above-a-Ring, WAR) (10) having the porous structure in the gold nanoparticle external frame through a galvanic substitution reaction, 500 μL of 0.1 M hexadecyltrimethylammonium chloride (CTAC) and 25 μL of 0.2 mM HAuCl₄ were added to 100 μL of the nanoparticle having a form in which silver was deposited on the gold-platinum nano-sized ring in a concentric manner and then reacted at 30° C. for 30 minutes.

Next, using a centrifuge, the synthesized nanoparticle was separated from the reagents remaining after the reaction. Then, a dilution process using distilled water was repeatedly performed three times to stop the reaction.

Through the process described above, the frame-structured nanoparticle (Au Web-Above-a-Ring, WAR) (10) having the porous structure in the gold nanoparticle external frame was successfully prepared through the galvanic substitution reaction in Preparation Example 2.

### Preparation Example 3

In Preparation Example 3, a frame-structured nanoparticle (Au Web-Above-a-Lens, WAL) (30) having a porous structure in both an external frame and a nanostructure positioned on an inner space of a ring-like shaped frame was prepared.

The nanoparticle was prepared through the following process corresponding to a specific preparation process.

All reactions occurred in an aqueous solution phase, and nanoparticles and reagents used were dispersed in tertiary distilled water.

First, a disk-form gold nanoparticle was prepared.

Next, in the presence of 50 μM iodine ions, 8 mL of the disk-form gold nanoparticle, 30 mL of 0.1 M hexadecyltrimethylammonium bromide (CTAB), 50 μL of 2 mM silver nitrate, and 960 μL of a 0.1 M ascorbic acid solution were added and mixed. Then, the mixed solution was maintained at 70° C. for 1 hour to form a silver thin film.

Next, 960 μL of 0.1 M hydrochloric acid and 200 μL of a 2 mM H₂PtCl₆ aqueous solution were added to the mixed solution. Then, a galvanic substitution reaction was performed on the resulting mixture at 70° C. for 12 hours to form a first platinum layer on the edge of the gold nanoparticles.

Next, using a centrifuge, the nanoparticle having a form in which the platinum layer was formed on the edge of the gold nanoparticle was separated from the reagents remaining after the reaction. Then, a dilution process using distilled water was repeatedly performed twice to stop the reaction.

Next, the gold nanoparticle in which the first platinum layer was formed was added to an aqueous solution in which 50 μL of 20 mM HAuCl₄ was added to 10 mL of a 0.1 M CTAB aqueous solution. Then, the gold portion was selectively etched at 50° C. for 30 minutes to synthesize a platinum single-frame structure.

Next, using a centrifuge, the synthesized nanoparticle was separated from the reagents remaining after the reaction. Then, a dilution process using distilled water was repeatedly performed twice to stop the reaction.

To obtain a platinum-containing nano-sized internal ring frame 100, 100 μL of 0.05 M CTAB, 30 μL of 2 mM HAuCl₄, 300 μL of 0.1 M ascorbic acid, and 20 μL of 0.1 M hydrochloric acid reacted in the presence of 50 μM iodine ions at 30° C. for 30 minutes in 100 μL of the platinum single-frame structure.

Next, using a centrifuge, the synthesized nanoparticle was separated from the reagents remaining after the reaction. Then, a dilution process using distilled water was repeatedly performed three times to stop the reaction.

To deposit silver in a concentric manner on the gold-platinum nano-sized ring (S310), 500 μL of 0.1 M hexadecyltrimethylammonium chloride (CTAC), 360 μL of 0.2 mM AgNO₃, 200 μL of 0.01 M ascorbic acid, and 200 μL of 50 mM sodium hydroxide were added to 100 μL of the nano-sized internal ring frame (100) and then reacted at 30° C. for 30 minutes.

Next, using a centrifuge, the synthesized nanoparticle was separated from the reagents remaining after the reaction. Then, a dilution process using distilled water was repeatedly performed three times to stop the reaction.

Next, to deposit silver in an eccentric manner on the nanoparticle having a form in which silver was deposited in a concentric manner on the gold-platinum nano-sized ring, 500 μL of 0.1 M CTAB, 360 μL of 0.2 mM AgNO₃, 200 μL of 0.01 M ascorbic acid, and 200 μL of 50 mM sodium hydroxide were added to 100 μL of the nanoparticle having a form in which silver was deposited on the gold-platinum nano-sized ring in a concentric manner and then reacted at 30° C. for 30 minutes.

Next, using a centrifuge, the synthesized nanoparticle was separated from the reagents remaining after the reaction. Then, a dilution process distilled water was repeatedly performed three times to stop the reaction.

To synthesize the frame-structured nanoparticle (Au Web-Above-a-Lens, WAL) (30) having the porous structure in both the external frame and the nanostructure positioned on the inner space of the ring-like shaped through a galvanic substitution reaction, 500 μL of 0.1 M hexadecyltrimethylammonium chloride (CTAC) and 200 μL of 0.2 mM HAuCl₄ were added to 100 μL of the nanoparticle having a form in which silver was deposited on the gold-platinum nano-sized ring in a concentric manner and then reacted at 30° C. for 30 minutes.

Next, using a centrifuge, the synthesized nanoparticle was separated from the reagents remaining after the reaction. Then, a dilution process using distilled water was repeatedly performed three times to stop the reaction.

Through the process described above, the frame-structured nanoparticle (Au Web-Above-a-Ring, WAR) (30) having the porous structure in both the external frame and the nanostructure positioned on the inner space of the ring-like shaped frame was successfully synthesized in Preparation Example 3.

### Experimental Example 1

In Experimental Example 1, the physical properties of the frame-structured nanoparticle (Au Nanolens, AN) (40) containing the nanostructure having the porous structure positioned on the inner space of the ring-like shaped frame, prepared in Preparation Example 1, were confirmed.

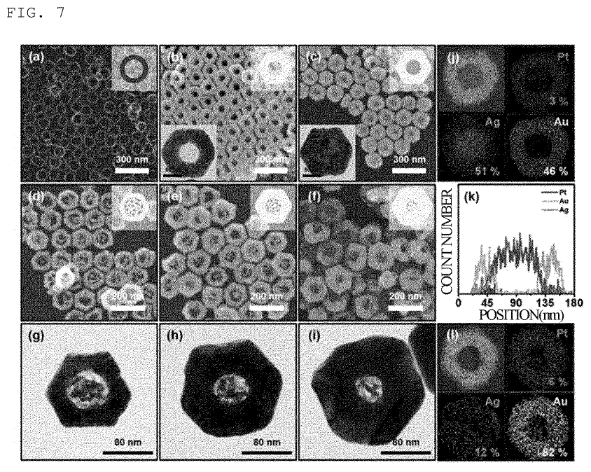

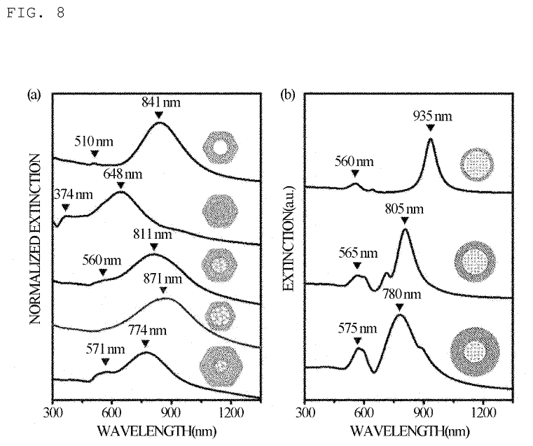

As seen from FIGS. 7 and 8, the frame-structured nanoparticle, provided by one embodiment of the present disclosure, has both the ring-frame structure positioned on the outer space of the ring-like shaped frame and the porous nanostructure positioned on the inner space of the ring-like shaped frame.

Additionally, depending on the size of the inner diameter of the ring-frame structure, the size of the inner diameter of the frame-structured nanoparticle (Au Nanolens, AN) (40) containing the porous nanostructure positioned on the inner space of the ring-shaped frame is controlled.

Additionally, according to the EDS mapping images of FIGS. 7J and 7K, in the case of the nanoparticle having a form in which silver was deposited in an eccentric manner on the gold-platinum nano-sized ring, it was confirmed that silver was selectively present only in the inner space of the ring-like shaped frame. Furthermore, according to the EDS mapping image of FIG. 7I, it was confirmed that the frame-structured nanoparticle (Au Nanolens, AN) (40) containing the porous nanostructure positioned on the inner space of the ring-like shaped frame, after the galvanic substitution reaction, was mostly made of gold.

### Experimental Example 2

In Experimental Example 2, the electromagnetic field focusing effect was tested using the frame-structured nanoparticle (Au Nanolens, AN) (40) containing the porous nanostructure positioned on the inner space of the ring-like shaped frame prepared in Preparation Example 1.

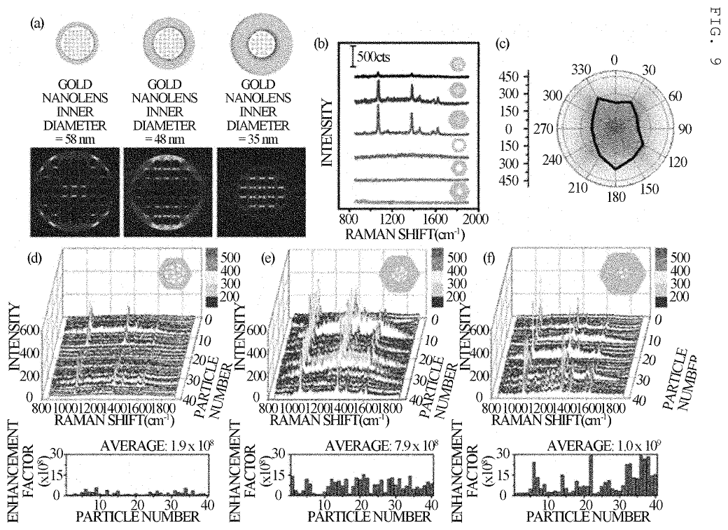

As seen from FIG. 9, according to the theoretical computer calculation results of FIG. 9A, it was confirmed that the smaller the diameter of inner space of the frame-structured nanoparticle (Au Nanolens, AN) (40) containing the porous nanostructure positioned on the inner space of the ring-like shaped frame, the more effectively the electromagnetic fields were focused within the porous nanostructure positioned on the inner space of the ring-like shaped frame.

Additionally, according to the results of the surface-enhanced Raman scattering for single particle of FIG. 9B, the ring-frame particles did not exhibit the surface-enhanced Raman scattering signals for single particle due to the lack of electromagnetic field focusing effect. On the contrary, the frame-structured nanoparticles (Au Nanolens, AN) (40) containing the porous nanostructure positioned on the inner space of the ring-like shaped frame exhibited the surface-enhanced Raman scattering signals for single particle due to the electromagnetic field focusing effect within the porous nanostructure positioned on the inner space of the ring-like shaped frame.

Additionally, the result of FIG. 9C means that the frame-structured nanoparticle (Au Nanolens, AN) (40) containing the porous nanostructure positioned on the inner space of the ring-like shaped frame exhibited single-particle surface-enhanced Raman scattering signals for polarization in all directions.

Additionally, the results of FIGS. 9D, 9E, and 9F mean that the frame-structured nanoparticle (Au Nanolens, AN) (40) containing the porous nanostructure positioned on the inner space of the ring-like shaped frame with varying inner diameters may exhibit single-particle surface-enhanced Raman scattering signals with high reproducibility.

### Experimental Example 3

In Experimental Example 3, the physical properties of the frame-structured nanoparticles, prepared in Preparation Examples 2 and 3, were confirmed.

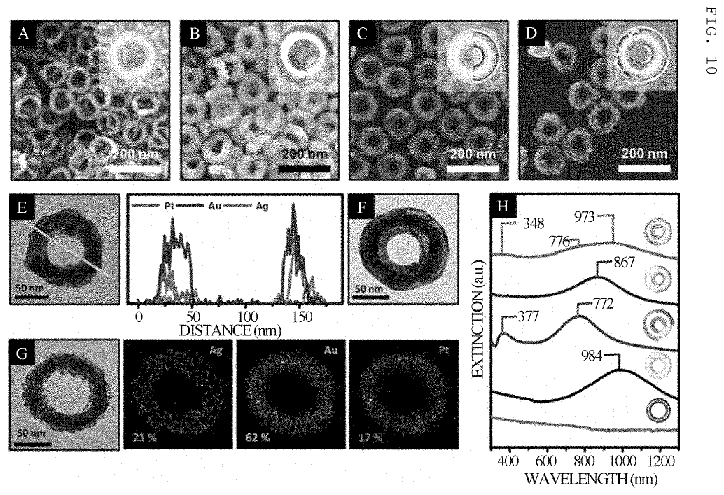

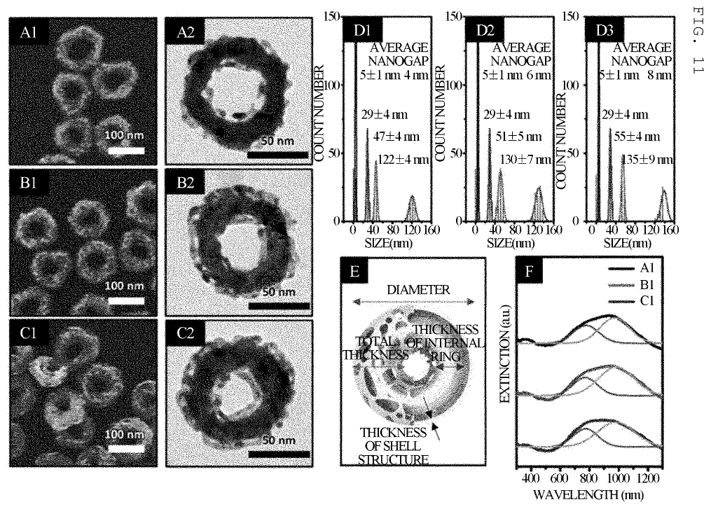

As seen from FIGS. 10 and 11, SEM and TEM images confirmed that the frame-structured nanoparticle (Au Web-Above-a-Ring, WAR) (10) having the porous structure in the gold nanoparticle external frame had the porous structure in the gold nanoparticle external frame.

Additionally, it was confirmed that the gap between the gold nanoparticle external frame and the porous structure was able to be adjusted for synthesis.

Additionally, according to UV-vis-NIR optical spectrum analysis results, it was confirmed that the frame-structured nanoparticle (Au Web-Above-a-Ring, WAR) (10) having the porous structure in the gold nanoparticle external frame absorbed or scattered light in a specific wavelength range.

### Experimental Example 4

In Experimental Example 4, the electromagnetic field focusing effect was tested using the frame-structured nanoparticles prepared in Preparation Examples 2 and 3.

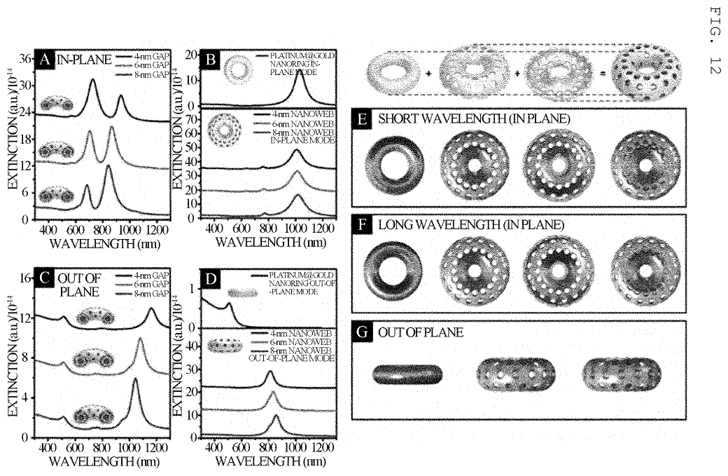

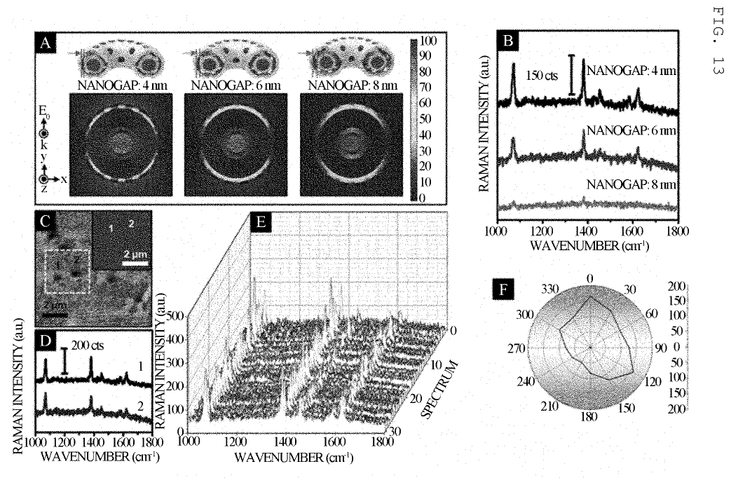

As seen from FIGS. 12 and 13, it was seen through theoretical computer calculation results and single-particle surface-enhanced Raman scattering signal measurement in FIG. 12 that the frame-structured nanoparticle (Au Web-Above-a-Ring, WAR) (10) having the porous structure in the gold nanoparticle external frame was capable of effectively focusing electromagnetic fields between the gold nanoparticle external frame and the porous structure.

Additionally, it was seen that the frame-structured nanoparticle (Au Web-Above-a-Ring, WAR) (10) having the porous structure in the gold nanoparticle external frame had a geometrically symmetric structure and thus were able to obtain single-particle surface-enhanced Raman scattering signals for polarization in all directions.

Additionally, in FIG. 13, it was confirmed on the basis of the electromagnetic field focusing effects within the porous nanostructure between the frame structure and the porous structure and in the inner space, that the frame-structured nanoparticle (Au Web-Above-a-Lens, WAL) (30) having the porous structure in both the external frame and the nanostructure positioned on the inner space of the ring-like shaped frame showed higher single-particle surface-enhanced Raman scattering signals than the frame-structured nanoparticle (Au Web-Above-a-Ring, WAR) (10) having the porous structure in the gold nanoparticle external frame and the frame-structured nanoparticle (Au Nanolens, AN) (40) containing the porous nanostructure positioned on the inner space of the ring-like shaped frame.

### Comparative Example

In this comparative example, an experiment was conducted to compare and confirm changes in electromagnetic field focusing effect on a frame-structured nanoparticle having a porous structure by varying the particle size of the porous nanostructure, in which the nanoparticle was characterized by containing a porous nanostructure positioned on an inner space of a ring-like shaped frame.

Referring to FIG. 9, FIGS. 9B, 9D, 9E, and 9F indicate that as the particle size of the porous nanostructure decreases, the electromagnetic field focusing effect of the porous nanostructure improves, resulting in higher surface-enhanced Raman signals. These results highlight the variation in electromagnetic field focusing effect with changing particle sizes.

The above description of the present disclosure is given by way of illustration only, and those skilled in the art will appreciate that various alternatives, modifications, and equivalents are possible, without changing the spirit or essential features of the present disclosure. Therefore, preferred embodiments of the present disclosure have been described for illustrative purposes and should not be construed as being restrictive. For example, each component described as a single type may be implemented to be distributed and similarly, components described to be distributed may also be implemented in an associated form.

The scope of the present disclosure is defined by the appended claims. All changes or modifications derived from the meaning and scope of the claims and the concept of equivalents should be construed to fall within the scope of the present disclosure.

1. A frame-structured nanoparticle of porous-structured, comprising:
a ring-like shaped frame comprising a nano-sized internal ring frame and a gold nanoparticle external frame, wherein the nano-sized internal ring frame comprises platinum, and wherein the gold nanoparticle external frame surrounds the nano-sized internal ring frame, and
wherein the gold nanoparticle external frame is a porous structure.

2. The frame-structured nanoparticle of claim 1,
wherein the porous nano-sized structure consists of nanoparticles that are entangled to each other, which provides a geometrically symmetric structure, and wherein the geometrically symmetric structure allows near-infrared rays incident on the porous nano-sized structure in all directions to be Raman-scattered.

3-6. (canceled)

7. The frame-structured nanoparticle of claim 1,
wherein the ring-like shaped frame further comprises a porous nanostructure positioned on inner space of the ring-like shaped frame.

8. The frame-structured nanoparticle of claim 7,
wherein the porous nanostructure consists of nanoparticles that are entangled to each other, which provides a geometrically symmetric structure, and
wherein the geometrically symmetric structure allows near-infrared rays incident on the porous nanostructure in all directions to be Raman-scattered.

9-13. (canceled)

14. A frame-structured nanoparticle of porous-structured, comprising:
a ring-like shaped frame comprising a nano-sized internal ring frame and a gold nanoparticle external frame, wherein the nano-sized internal ring frame comprises platinum, and wherein the gold nanoparticle external frame surrounds the nano-sized internal ring frame; and
a porous nanostructure positioned on inner space of the ring-like shaped frame.

15. The frame-structured nanoparticle of claim 14,
wherein the porous nanostructure comprises an inner part of the porous nanostructure and an outer part of the porous nanostructure, wherein the inner part of the porous nanostructure comprises a structure which consists of nanoparticles that are entangled to each other, and wherein the outer part of the porous nanostructure is connected to the ring-like shaped frame.

16. The frame-structured nanoparticle of claim 14,
wherein the porous nanostructure consists of nanoparticles that are entangled to each other, which provides a geometrically symmetric structure, and wherein the geometrically symmetric structure allows near-infrared rays incident on the porous nano-sized structure in all directions to be Raman-scattered.

17. The frame-structured nanoparticle of claim 14,
wherein the ring-like shaped frame comprises an outer portion of nano-sized external frame which has a triangular to hexagonal structure.

18. The frame-structured nanoparticle of claim 14,
wherein a thickness of the ring-like shaped frame is within 39 nm to 51 nm,
wherein an outer diameter of the ring-like shaped frame is within 103 nm to 150 nm, and
wherein an inner diameter of the ring-like shaped frame is within 35 nm to 54 nm.

19-23. (canceled)

24. A spectroscopy sample for Surface-Enhanced Raman Scattering (SERS) comprising the frame-structured nanoparticle of porous-structured of claim 1.

25. A spectroscopy sample for Surface-Enhanced Raman Scattering (SERS) comprising the frame-structured nanoparticle of porous-structured of claim 7.

26. A spectroscopy sample for Surface-Enhanced Raman Scattering (SERS) comprising the frame-structured nanoparticle of porous-structured of claim 14.

27. A method for making a frame-structured nanoparticle of porous-structured, the method comprising:
1) preparing a ring-like shaped frame comprising a nano-sized internal ring frame and a gold nanoparticle external frame, the nano-sized internal ring frame comprises platinum, and wherein the gold nanoparticle external frame surrounds the nano-sized internal ring frame;
2) depositing silver on the ring-like shaped frame; and
3) after the depositing silver, performing a galvanic substitution reaction such that the deposited silver is substituted, forming a gold nanoparticle external frame of porous-structured,
wherein the silver deposition step of step 2) comprises one step selected from the following i) to iii):
i) depositing silver on a surface of the ring-like shaped frame in order that silver is deposited in a concentric manner on the ring-like shaped frame;
ii) depositing silver in a concentric manner on the ring-like shaped frame such that a surface of the ring-like shaped frame is surrounded by silver; and after depositing silver in a concentric manner, depositing silver in an eccentric manner such that inner space of the ring-like shaped frame is deposited by silver; or
iii) depositing silver in an eccentric manner on the ring-like shaped frame such that the silver is deposited on inner space of the ring-like shaped frame,
in the case of step ii), the substitution step of step 3) is to perform a galvanic substitution reaction after depositing silver in an eccentric manner.

28. The method of claim 27,
wherein the depositing silver in the step i) comprises:
controlling standard reduction potential of silver by using solution comprising halogen anions and silver anions, and applying a potential higher than both an inner-side surface energy of the ring-like shaped frame and an outer-side surface energy of the ring-like shaped frame, which allows the silver to be deposited in a concentric manner.

29. The method of claim 27,
wherein the performing a galvanic substitution reaction comprises:
adding compound providing Au³⁺ cation to allow a reaction of Reaction Scheme 1 as below, or
adding compound providing Pt⁴⁺ cation to allow a reaction of Reaction Scheme 2 as below:
3Ag(s +AuX⁻(aq)->Au(s)+3Ag⁺(aq)+4X⁻(aq) [Reaction Scheme 1]
(X is a halogen element)
4Ag(s)+Pt⁴⁺(aq)->Pt(s)+4Ag⁺(aq). [Reaction Scheme 2]

30. The method of claim 27,
wherein the performing a galvanic substitution reaction comprises a Kirkendall reaction, and
wherein the Kirkendall reaction comprises an oxidation of silver on surface causing dissolving of Ag⁺, a migration of silver inside of metal into surface for minimizing surface energy, and an oxidation of the silver migrated into the surface.

31. The method of claim 27,
wherein the depositing silver in a concentric manner in the step ii) comprises:
controlling standard reduction potential of silver by using solution comprising halogen anions and silver anions, and applying a potential higher than both an inner-side surface energy of the ring-like shaped frame and an outer-side surface energy of the ring-like shaped frame, which allows the silver to be deposited in a concentric manner.

32. The method of claim 27,
wherein the depositing silver in an eccentric manner in the step ii) is performed after the depositing silver in a concentric manner to induce the ring-like shaped frame to be deposited by silver.

33. The method of claim 27,
wherein the depositing silver in an eccentric manner in the step iii) comprises:
controlling standard reduction potential of silver by using solution comprising halogen anions and silver anions, and applying a potential between an inner-side surface energy of the ring-like shaped frame and an outer-side surface energy of the ring-like shaped frame, which allows the silver to be deposited in an eccentric manner.

34. The method of claim 33, wherein the halogen ions comprise bromide ion.
